(19) United States
(12) Patent Application Publication
(10) Pub. No.: US 2012/0323683 A1
(43) Pub. Date: Dec. 20, 2012

(54) INTERACTIVE ONLINE LOYALTY PLATFORM WITH UNIVERSAL VIRTUAL CURRENCY

(76) Inventors: Brian David Feldman, Potomac, MD (US); Matthew Harrison Meyer, South Pleasantville, NY (US)

(21) Appl. No.: 13/163,180

(22) Filed: Jun. 17, 2011

(51) Int. Cl. G06Q 30/00

(52) U.S. Cl. 705/14.53; 705/14.4

(57) ABSTRACT

A method for exchanging virtual currency for goods or services. The method can comprise storing data associated with customers and businesses in a database, updating the data associated with the customers and businesses to include changes in the amount of a virtual currency owned by the customers and businesses caused by interactions in a virtual environment, allowing the businesses to create promotions, allowing the customers to purchase promotions using the virtual currency, and allowing the customers to redeem purchased promotions for discounts on one or more goods or services at the physical locations of the businesses.

### BACKGROUND

Interactive online environments have grown increasingly popular in recent years. Virtual worlds and online games such as “World of Warcraft” and Linden Labs' “Second Life” now boast millions of registered users. Often, games such as these operate with complex internal economies which make use of their own virtual currencies. Due to the size of these games and the number of subscribers, many times these currencies can become extremely valuable. Additionally, these games can offer a way for players to purchase currency within the games using real world currency, however once the currency within the game is purchased, there is no real world value or way to exchange it for actual currency.

Unfortunately, despite their value, these currencies are not transferrable to the physical world. There exists no gaming platform in which virtual points earned through normal gameplay lead to direct, real-world benefits from a broad range of businesses. As a result, the virtual wealth of many users, many of whom expended considerable effort, must often go to waste.

### SUMMARY

In one exemplary embodiment, a method for exchanging virtual currency for goods or services can be disclosed. The method can comprise storing data associated with customers and businesses in a database, updating the data associated with the customers and businesses to include changes in the amount of a virtual currency owned by the customers and businesses caused by interactions in a virtual environment, allowing the businesses to create promotions, allowing the customers to purchase promotions using the virtual currency, and allowing the customers to redeem purchased promotions for discounts on one or more goods or services at the physical locations of the businesses.

In another exemplary embodiment, a system for exchanging virtual currency for goods or services can be disclosed. The system can comprise a central server capable of hosting a virtual environment, at least one device capable of sending and receiving data from the server and adapted to be used by a business, at least one device capable of sending and receiving data to and from the server and adapted to be used by a customer, and a virtual currency found in a realm on the central server.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 is a front view of an exemplary diagram of an interactive online loyalty platform.

FIG. 2 is a diagram representing an exemplary interaction between a business and an interactive online loyalty platform.

FIG. 3 is a diagram representing an exemplary interaction between a customer and an interactive online loyalty platform.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a digital control system and the digital signal processing (DSP) devices. It will be recognized that various actions described herein can be performed by specific circuits (e.g., application specific integrated circuits (ASICs)), by program instructions being executed by one or more processors, or by a combination of both. Additionally, these sequences of actions and processes described herein can be considered to be embodied entirely within any form of computer platform having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

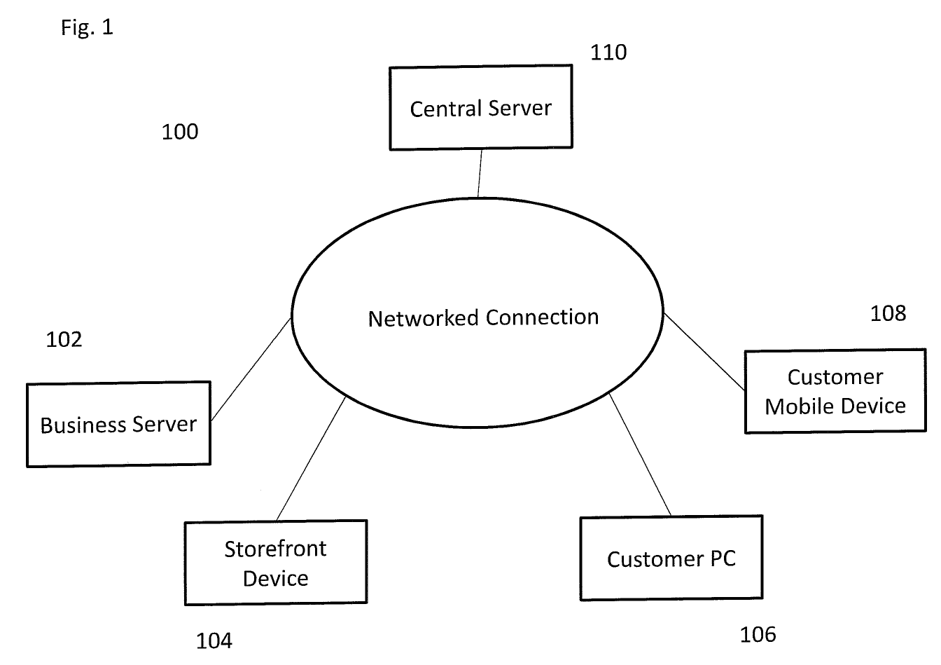

FIGS. 1-3 generally refer to a platform with an associated currency or medium of exchange that can be used in a networked computer system, for example while playing a massively multiplayer online role-playing game. This currency, which may be a virtual currency, can be traded or exchanged between individual users of the computer system, and between users of the computer system and entities such as businesses. Additionally, the currency may be generated in any fashion and in any denominations, and may have a value that is independent of any one real world currency. The currency can be exchanged for goods or services performed or delivered outside of the networked computer system, or for benefits such as coupons or discounts. The platform and the currency can be used by entities such as businesses to track the activities of users of the computer system and use the information gathered to provide benefits to the users. Additionally, the currency used by the computer system may emulate physical currency, insofar as interactions between players, businesses and any other entities that involve currency can be such that the party receiving any currency may be free to save the currency or use it for any desired purpose; i.e. it is not absorbed by the computer system and it can be saved or used as desired.

Exemplary FIG. 1 depicts an illustration of an exemplary embodiment of a platform 100. Platform 100 can be adapted to use computers and other devices which can be operated by entities such as businesses, as well as computers and other devices which can be operated by users such as customers. These computers and other devices can include business server 102 and storefront device 104, which can be operated by a business, and computer 106 and mobile device 108, which can be operated by a customer. Platform 100 can also be adapted to use central server 110, which can store account information related to businesses and customers, and can also run an interactive virtual environment, such as a massively-multiplayer online role-playing game, with which platform 100 may be associated. Business server 102, storefront device 104, customer computer 106, and customer mobile device 108 can communicate with each other and with central server 110 through a networked connection, such as the internet. Central server 110 may have storage capabilities and may be capable of storing any desired information in databases, for example data regarding a customer or business, as well as any desired account information for any customer or business.

Still referring to FIG. 1, storefront device 104 can include a barcode scanner or any other type of known scanning device, and can communicate with other objects and devices in any desired manner, for example Radio-Frequency Identification, Near-Field Communication, Bluetooth, Wireless Internet, Short Message Service, Multimedia Message Service, or any other method of communication. Storefront device 104 can include software such as Scanner Assistant Software which can interact with business server 102, customer computer 106, customer mobile device 108, and central server 110. Customer mobile device 108 can be any sort of mobile device, for example a laptop or handheld computer, a cellular device such as a smartphone, or any other type of mobile device capable of accessing a network, send and receiving data and displaying content. Customer mobile device 108 can interact with other objects in any desired manner, such as Radio-Frequency Identification, Near-Field Communication, Bluetooth, Wireless Internet, Short Message Service, Multimedia Message Service, or any other method of communication. Customer mobile device 108 can further include software which can interact with business server 102, customer computer 106, customer mobile device 108, and central server 110.

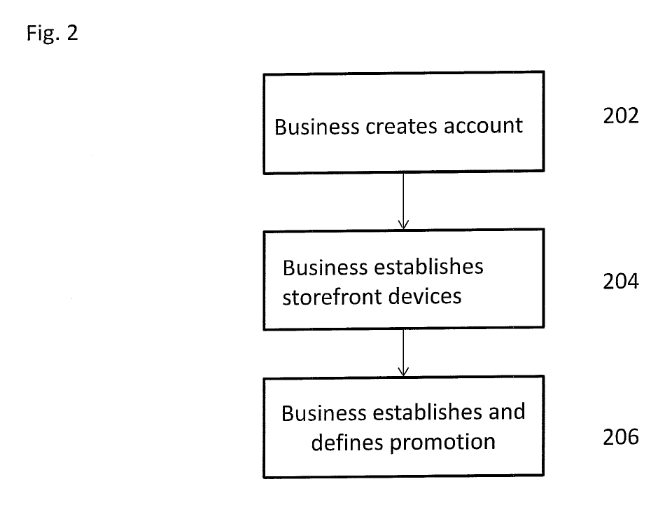

FIG. 2 is a diagram of an exemplary embodiment of an interaction between an entity such as a business and an exemplary embodiment of a platform 100. At step 202, a business can create an account on central server 110 in which data relating to the business can be stored and accessed. At step 204, a business can install one or more storefront devices 104 in one or more physical locations associated with the business. The storefront devices 104 can track any transactions that take place within the physical location and can store data associated with these transactions on business server 102, which can update business account information on central server 110 accordingly. At step 206, a business can establish a promotion such as a discount or coupon and determine conditions or restrictions for its use. These promotions can include for example the exchange of virtual currency for full or partial discounts on goods or services, or the reward of virtual currency in recognition of accomplishments inside or outside of the computer system associated with platform 100. The business can enter this promotion and its associated rules into business server 102, storefront device 104, or any other device associated with the platform 100. Central server 110 can recognize these promotions and make them available to customers in virtual or online storefronts associated the business which can be accessible through platform 100.

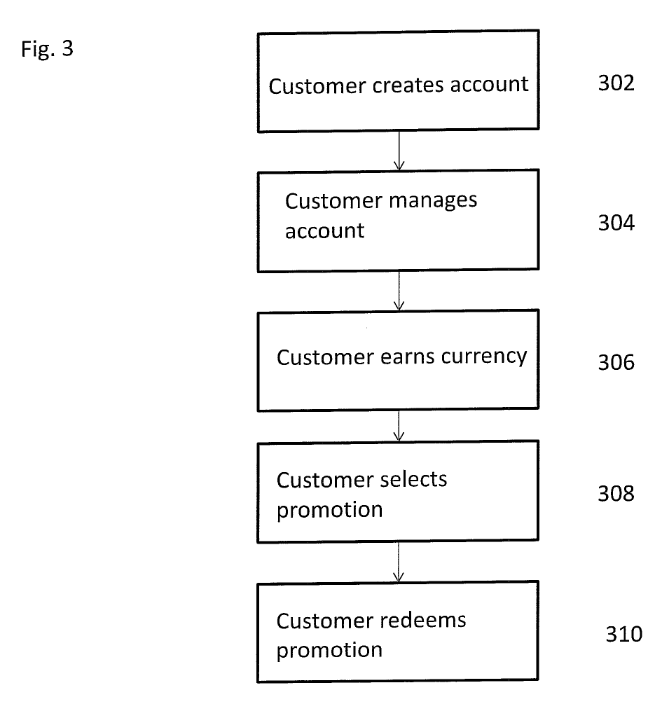

FIG. 3 is a diagram of an exemplary embodiment of an interaction between a customer and an exemplary embodiment of the platform 100. At step 302, a customer can create an account on central server 110 in which data relating to the customer can be stored and accessed. At step 304, a customer can access account data on central server 110 through customer computer 106 or mobile device 108, for example by downloading an application. At step 306, a customer can earn virtual currency by participating in interactions in a virtual environment associated with platform 100, for example a massively multiplayer online role-playing game. Such interactions can include, but are not limited to, interactions with other players on the game, interactions with virtual environments in the game or interactions with virtual entities in the game, as well as some interactions between physical entities and environments within the game. Central server 110 can update data associated with the customer's account to reflect the addition of currency. This currency can come from other customers or from a central bank account associated with platform 100. In some exemplary embodiments, a finite amount of currency can be available, and the amount of credits disbursed from the central bank account can be managed by the administrators of the platform 100.

Still referring to exemplary FIG. 3, at step 308, a customer can select a desired promotion from a business by using customer computer 106 or mobile device 108 to access a virtual or online storefront associated with the business which is accessible through platform 100. Once a selection has been made, central server 110 can update data associated with the customer's account to indicate the acquisition of the promotion and the subtraction of virtual currency, and can place the virtual currency used for the purchase into an escrow account. At step 310, a customer can redeem a purchased promotion at a business's physical location by, for example, scanning mobile device 108 with storefront device 104 at the time of purchase of a good or service. The Scanner Assistant Software on storefront device 104, or any other desired software, can access business server 102 and use data contained in the business's account to evaluate the promotion as presented by mobile device 108. If the promotion is applicable to the good or service being purchased, business server 102 can access central server 110, which can transfer the virtual currency in the escrow account associated with the promotional transaction into the business's account and update data in the accounts of the business and the customer to reflect the details of the transaction. These details can include a running count of the amount and type interactions between the customer and the business, which can be used to modify the promotions that are available to the customer.

In still further exemplary embodiments, it may be appreciated that upon the selection of a desired promotion in 308, an indicia of that promotion may be provided to the customer. An indicia can include a message, such as a message with a coupon and a scannable or readable code that the customer may be able to get a physical copy of, for example by printing. The printed copy may then be redeemed at a business's physical location following it being scanned or read by an appropriate device. Following such a scanning or reading, any appropriate accounts may then be updated.

In still another exemplary embodiment, an online or virtual currency may be generated in any of a variety of fashions. As discussed above, currency may be earned or accumulated through virtual interactions. Additionally, currency may be provided to players or customers through contact with one or more businesses in a game or virtual world. For example, after a business has accumulated a desired amount of currency in its accounts, it may send offers or messages to any desired players of a game. In return for opening the message, reading the message or performing some other task, a business may provide currency to the player that the message was sent to. This can incentivize players to read messages or perform tasks, as well as provide a platform for businesses to make any desired number of parties aware of content, materials, goods or services that the business may provide.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for exchanging virtual currency for goods or services, comprising:
storing data associated with at least one customer in a database;
storing data associated with at least one business in a database;
updating the data associated with the at least one customer to include changes in the amount of a virtual currency owned by the at least one customer caused by interactions in a virtual environment;
creating promotions by the at least one business and displaying them in the virtual environment;
updating the data associated with the at least one business to include available promotions;
purchasing promotions provided by the at least one business by the customer using the virtual currency;
updating the data associated with the at least one customer to include a deduction of virtual currency associated with the purchased promotion;
redeeming purchased promotions by the at least one customer for one or more goods or services from the at least one business at a physical location of the at least one business; and
updating the data associated with the at least one business to include an increase of virtual currency associated with the redeemed promotion.

2. The method of claim 1, further comprising:
updating the data associated with the at least one business and at least one customer to include a history of the transaction; and
modifying subsequent promotions available to the at least one customer based on previous transactions with the at least one business.

3. The method of claim 1, wherein the promotion comprises at least one of a coupon, discount, item, benefit, good, or service.

4. A system for exchanging virtual currency for goods or services, comprising:
a central server capable of hosting a virtual environment;
at least one device capable of sending and receiving data from the server and adapted to be used by a business;
at least one device capable of sending and receiving data to and from the server and adapted to be used by a customer; and
a virtual currency found in a realm on the central server, wherein:
a customer uses the customer device to interact with the virtual environment hosted on the server;
the server stores and updates data associated with the customer, including changes in the user's virtual currency caused by interactions in the virtual environment;
a business can use the business device to create and manage promotions;
the server stores and updates data associated with the business, including available promotions;
a user can browse and, using the virtual currency, purchase promotions in the virtual environment;
the server updates the data associated with the customer to reflect purchases of promotions by associating the promotion with the customer and deducting virtual currency from the customer;
a customer can use the customer device or the business device to redeem a purchased promotion at a business's physical location; and
the server updates the data associated with the business to reflect redemption of promotions by adding virtual currency to the business.

5. The system of claim 4, wherein the business device is a server configured to communicate with the central server and the customer device.

6. The system of claim 4, wherein the business device is an interactive storefront device that communicates with the central server and a mobile customer device.

7. The system of claim 4, wherein the customer device is at least one of a personal computer, laptop computer, handheld computer, or mobile device such as a cellular telephone or smartphone.

8. The system of claim 4, wherein the promotion comprises at least one of a coupon, discount, item, benefit, good, or service.

9. The system of claim 4, wherein the server stores data concerning the transaction as part of a transaction history between a customer and a business; and
a business modifies the promotions available to a customer based on the customer's transaction history with the business.
